(19) United States
(12) Patent Application Publication
(10) Pub. No.: US 2015/0363827 A1
(43) Pub. Date: Dec. 17, 2015

(54) SELECTING CONTENT FOR PRESENTATION TO A SOCIAL NETWORKING SYSTEM USER BASED ON WHETHER THE USER IS TRAVELING

(71) Applicant: Facebook, Inc., Menlo Park, CA (US)

(72) Inventor: Erick Tseng, San Francisco, CA (US)

(21) Appl. No.: 14/301,592

(22) Filed: Jun. 11, 2014

(51) Int. Cl. G06Q 30/02; G06Q 50/00

(52) U.S. Cl. CPC G06Q 30/0261; G06Q 50/01

(57) ABSTRACT

A social networking system maintains a home location associated with a user and determines a current location associated with the user. By comparing the home location to the current location, the social networking system determines whether the user is traveling. For example, if the current location is greater than a threshold distance from the home location, the social networking system determines that the user is traveling. When selecting content for presentation to the user, the social networking system accounts for whether the user is traveling. For example, advertisement requests including targeting criteria that a user is traveling are selected as eligible for presentation to a user determined to be traveling.

### BACKGROUND

This disclosure relates generally to social networking systems, and in particular to identifying advertisement content eligible for presentation to a social networking system user.

A social networking system allows users to connect to and to communicate with other users of the social networking system. Users create profiles on a social networking system that are tied to their identities and include information about the users, such as interests and demographic information. The users may be individuals or entities such as corporations or charities. Because of the increasing popularity of social networking systems and the significant amount of user-specific information maintained by social networking systems, a social networking system provides an ideal forum for advertisers to increase awareness about products or services by presenting advertisements to social networking system users.

Presenting advertisements to social networking system users allows an advertiser to gain public attention for products or services or to persuade social networking system users to take an action regarding the advertiser's products or services. Many social networking systems generate revenue by displaying advertisements to their users. Frequently, social networking systems charge advertisers for each presentation of an advertisement to a social networking system user (e.g., each “impression” of the advertisement) or interaction with an advertisement by a social networking system user.

To increase the likelihood of social networking system users interacting with an advertisement, various targeting criteria may be associated with the advertisement. The advertisement is subsequently presented to users having characteristics satisfying the targeting criteria. Frequently, targeting criteria associated with an advertisement specifies a physical location, so the advertisement is eligible for presentation to users within a threshold distance of the specified physical location. While a physical location associated with the user may satisfy an advertisement's targeting criteria, targeting based on physical location alone does not account for types of activities a user may engage in while at a particular location. This may result in selection of advertisements with which the user is less likely to interact for presentation to the user because the selected advertisements are less relevant to activities in which the user is likely to engage while at a location.

### SUMMARY

A social networking system analyzes information associated with a user of the social networking system and received by the social networking system to determine whether the user is traveling. The social networking system maintains a user profile associated with the user, with the user profile including a home location associated with the user (e.g., a hometown, a residence). The home location may be specified by the user or may be determined by the social networking system based on location information associated with content provided to the social networking system by the user. For example, physical locations associated with posts or other content provided to the social networking system by the user are analyzed to identify a home location associated with the user. Additionally, the social networking system determines a current location associated with the user based on location information associated with content provided to the social networking system by the user. For example, the social networking system 140 extracts location information from content including a post, a check-in, an acceptance of an invitation to an event by the user, a description of an event generated by a user, or calendar information associated with the user and determines a current physical location associated with the user from the extracted location information. For example, a physical location associated with at least a threshold number or percentage of content items provided to the social networking system by the user within a threshold time interval is the user's current location. Alternatively, information received by the social networking system from a position sensor in a client device associated with the user specifies the current location of the user.

To determine whether the user is traveling, the social networking system compares the current location and the home location. For example, if a distance between the current location and the home location equals or exceeds a threshold amount, the social networking system determines the user is traveling and stores a value indicating the user is traveling in the user's user profile. In some embodiments, after determining the user is traveling, the social networking system determines a type of travel based on information associated with the user received by the social networking system. For example, the social networking system determines whether the travel is business travel or personal traveling by identifying additional users connected to the user and also associated with content associated with the user and determining the type of travel based on types of connections between the user and the additional users.

Based at least in part on the indication whether the user is traveling, the social networking system selects content for presentation to the user. For example, advertisement requests including targeting criteria indicating that a user is traveling are identified as eligible for presentation to a user with an indication in the user's user profile that the user is traveling. Additionally, a determined type of travel may also be used when selecting content for presentation to the user.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method for identifying a content items for presentation to a user based on determination of whether the user is traveling, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

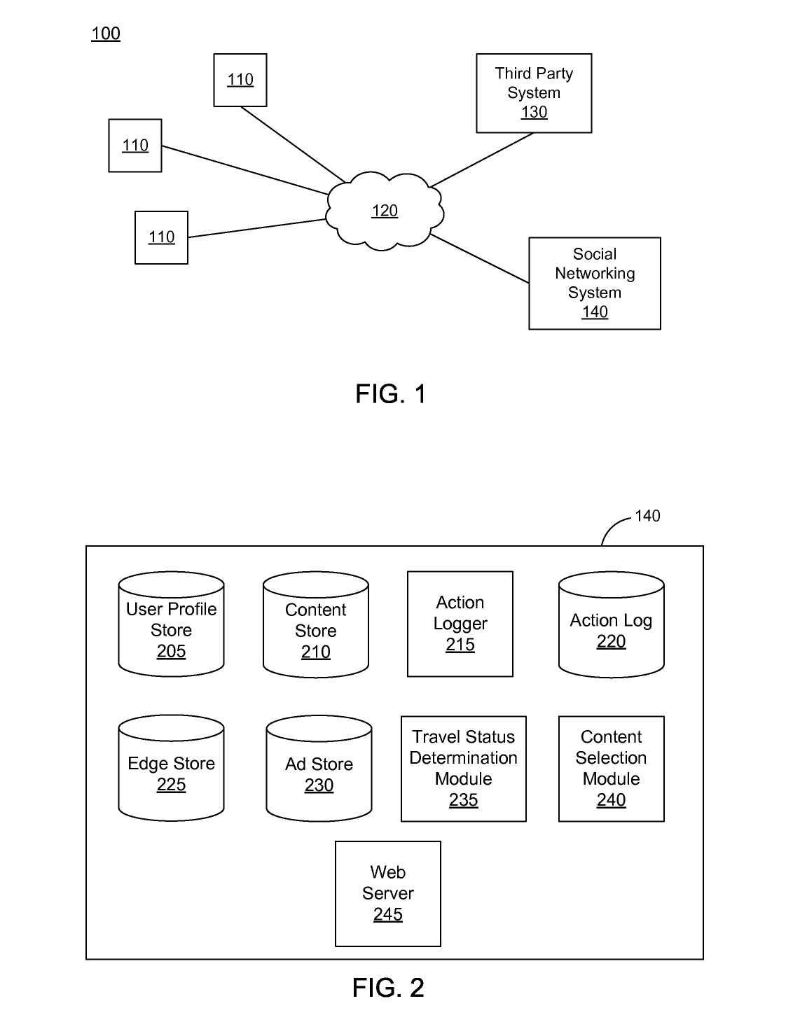

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an advertisement (“ad”) store 230, a travel status determination module 235, a content selection module 240, and a web server 245. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

In various embodiments, multiple physical locations associated with a user are included in the user's user profile. For example, a home location associated with a user and specified by the user or determined from content provided to the social networking system 140 by the user. The home location may identify a hometown of the user, a residence of the user, or other suitable physical location associated with the user. Including a home location in a user profile allows the social networking system 140 to identify a physical location where a user is likely to spend at least a threshold amount of time. In addition to the home location, a user profile may include information identifying a current location of a user, allowing the social networking system 140 to identify changes in the user's location over time.

The social networking system 140 determines a current location associated with a user based on received information that is associated with the user. For example, the social networking system 140 extracts location information from content provided to the social networking system 140 by the user. Examples of content from which location information is extracted include a post including location information, a check-in to a location by the user, an acceptance of an invitation to an event by the user, calendar information associated with the user, and a message to another user including location information. Based on location information from content provided to the social networking system 140 associated with a time interval, the social networking system 140 determines a current location associated with the user during the time interval. Alternatively, the social networking system 140 identifies a current location of the user based on information received by the social networking system 140 from a client device 110 executing an application associated with the social networking system 140 and associated with the user, such as location information communicated to the social networking system 140 from a position sensor (e.g., a Global Positioning System sensor) included in the client device 110.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140. In one embodiment, the content store 210 includes one or more user identifiers that identify one or more social networking system users presented with a content item that are stored in association with the stored content item.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

Targeting criteria included in an advertisement request may identify a travel status for identifying whether a user is eligible to be presented with an advertisement from the advertisement request. A travel status is a value indicating whether a user is traveling or is not traveling. In one embodiment, a travel status is a binary value with a value indicating the user is traveling and an alternative value indicating the user is not traveling. Including a travel status in targeting criteria allows an advertiser to target advertisements identified in certain advertisement requests for presentation to users that are traveling, providing the advertiser with greater control over the presentation of advertisements to social networking system users. For example, certain products or services (e.g., discounts for hotels or travel services) are more likely to be relevant to users who are traveling, so an advertiser includes a travel status indicating a user is traveling in advertisement requests for the products or services to present advertisement content to traveling users who are more likely to interact with the advertisement content. Additionally, targeting criteria may also identify a type of travel so certain advertisement requests are identified as eligible for presentation to users traveling for business, while other advertisement requests are identified as eligible for presentation to users traveling for personal reasons.

A travel status determination module 235 retrieves a current location and a home location associated with a user from a user profile associated with the user and included in the user profile store 205. By comparing the current location and the home location, the travel status determination module 235 determines whether the user is traveling and stores a travel status in the user profile indicating whether the user is traveling. In one embodiment, the travel status determination module 235 determines a distance between the current location associated with a user and a home location associated with the user and determines whether the user is traveling based on the distance. For example, if the distance between the current location and the home location equals or exceeds a threshold amount, the travel status determination module 235 determines the user is traveling and stores a value of the travel status in the user's user profile indicating the user is traveling. In other embodiments, the travel status determination module 235 determines whether the user is traveling based on information associated with the current location describing one or more characteristics of the current location. For example, the travel status determination module 235 determines a location type associated with the current location indicating whether the current location is a personal location, a business location, a tourist location, or any other suitable characteristic of the current location. Example location types include a personal location (e.g., a tourist location or an entertainment location) and a business location type (e.g., convention center, professional conference, or office building). For example, the travel status determination module 235 determines that the current location of a user has a business location type based on information extracted from a post shared by the user indicating that the user is attending a professional conference at a convention center in San Francisco. In this example, even if the home location associated with the user is San Francisco, the travel status determination module 235 determines that the user is traveling based on the determined location type associated with the user's current location. In some embodiments, the travel status determination module 235 stores an alternative value of the travel status in the user's user profile indicating the user is not traveling if the distance between the current location and the home location is less than the threshold amount. Alternatively, the travel status determination module 235 does not store a travel status in the user's user profile if the travel status determination module 235 determines the user is not traveling.

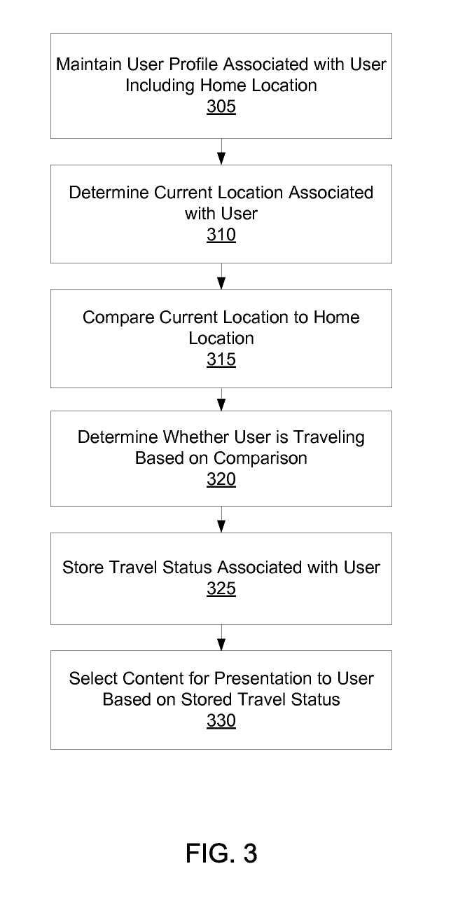

In some embodiments, if the travel status determination module 235 determines the user is traveling, the travel status determination module also determines a type of travel associated with the user. The type of travel is determined based on information associated with the user by the social networking system 140. For example, the social networking system 140 retrieves content associated with the user and identifying the current location or retrieves content associated with the user and received within a threshold amount of time from the determination the user is traveling. Additional users connected to the user are identified by the travel determination module 235, which determines whether the travel is business travel or personal travel based on types of connections between the user and the additional users. For example, if at least a threshold number of additional users have connections to the user indicating the user and the additional users are coworkers, the travel determination module 235 determines the type of travel is business travel. As another example, information from user profiles associated with the additional users is retrieved and if at least a threshold number or percentage of the additional users specify an employer in their user profiles matching an employer specified by a user profile of the user, the travel determination module 235 determines the type of travel is business travel. In another example, the travel determination module 235 extracts words or phrases from content associated with the current location and analyzes the words or phrases to determine whether the type of travel is business travel or personal travel (e.g., various words or phrases may be associated with business travel or personal travel by the social networking system 140 and compared to words or phrases extracted from content associated with the current location). For example, the travel status determination module 235 determines whether a user is traveling for business or personal reasons based on a location type associated with the user's current location as previously discussed. Information identifying a type of travel is stored in a user's user profile along with the travel status value. Determination of a travel status and a type of travel is further described below in conjunction with FIG. 3.

When an opportunity to present advertisement content to a user of the social networking system 140 is identified, the content selection module 240 identifies one or more content items for presentation to the user. For example, the content selection module 240 identifies ad requests from the ad store 230 eligible for presentation to the user and selects one or more of the eligible ad requests for presentation to the user. To identify ad requests eligible for presentation to a user, the content selection module 240 retrieves information associated with the user from one or more of the user profile store 205, the action log 220, and the edge store 225 and compares the retrieved information to targeting criteria included in various ad requests from the ad store 230. Ad requests including at least a threshold number or percentage of targeting criteria satisfied by the retrieved information associated with the user are identified as eligible for presentation to the user and included in a selection process to select advertisement content from one or more ad requests for presentation to the user.

To determine if a user is associated with information satisfying a travel status specified by targeting criteria of an ad request, the content selection module 240 retrieves a travel status from a user profile and determines whether the retrieved travel status matches the travel status specified by the targeting criteria. If the travel status retrieved from the user profile matches the travel status specified by the targeting criteria of the ad request, the ad request is identified as eligible for presentation to the user. Similarly, a type of travel specified by a user profile is compared to a type of travel specified by targeting criteria of the ad request, and the ad request is identified as eligible for presentation to the user if the type of travel in the user profile matches the type of travel specified by the targeting criteria.

Ad requests identified as eligible for presentation to the user are included in a selection process that identifies advertisement content associated with one or more ad requests for presentation to the user. In one embodiment, the content selection module 240 uses an auction process that ranks eligible ad requests based on expected values to the social networking system 140 for presenting advertisement content from each of the eligible ad requests, with an expected value of an ad request based on a bid amount associated with the ad request and a likelihood of the user interacting with advertisement content in the ad request. Based the ranking, the content selection module 240 selects one or more of the eligible ad requests and communicates advertisement content from the selected ad requests to a client device 110 for presentation to the user. The content selection module 240 also determines an amount charged to an advertiser associated with a selected ad request based on bid amounts or expected values associated with various ad requests included in the selection process. In various embodiments, any suitable process for selecting ad requests may be applied to the eligible ad requests by the content selection module 240.

Additionally, the content selection module 240 may account for a travel status associated with a user when selecting other content items for presentation to the user. For example, the content selection module 240 increases a measure of affinity of the user for a content item (e.g., a story describing an action performed by another social networking system user) associated with a location within a threshold distance of the user's current location if the user is determined to be traveling. As another example, the content selection module 240 increases a measure of affinity of the user for content items including one or more terms or phrases associated with travel if the user is determined to be traveling. Modifying the measures of affinity of the user for various content items increases the likelihood of the content items being presented to the user.

The web server 245 links the social networking system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the social networking system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Selecting Content for Presentation to a User Based on Travel Status

FIG. 3 is flowchart of one embodiment of a method for identifying content items for presentation to a user based on determination of whether the user is traveling. In other embodiments, the method includes different, additional, or fewer steps than those depicted by FIG. 3. Additionally, in some embodiments, the steps described in conjunction with FIG. 3 may be performed in different orders.

The social networking system 140 maintains 305 a user profile associated with a user of the social networking system 140 that includes characteristics or information associated with the user. For example, the user profile includes demographic information associated with a user. Additionally, the user profile includes one or more physical locations associated with the user. For example, the user profile identifies a home location associated with the user (e.g., a hometown or residence associated with the user). As described above in conjunction with FIG. 2, the home location may be specified by the user or may be determined by the social networking system 140 based on location information associated with content provided to the social networking system 140 by the user. For example, the social networking system 140 identifies a physical location associated with at least a threshold number or percentage of content items provided to the social networking system 140 by the user within a time interval as the home location associated with the user.

Based on information associated with the user, the social networking system 140 determines 310 a current physical location associated with the user. In one embodiment, the social networking system 140 extracts location information from content provided to the social networking system by the user and determines 310 a current physical location associated with the user from the extracted location information. Examples of content from which location information is extracted include a post including location information, a check-in to a location by the user, an acceptance of an invitation to an event by the user, calendar information associated with the user, and a message to another user including location information. A current physical location is determined 310 as a physical location associated with location information extracted from a threshold number or percentage of content items provided to the social networking system 140 by the user within a specified time interval. In some embodiments, weights are associated with location information extracted from different types of content, and the current location is determined 310 by applying the weights to location information to determine values associated with different location information. The social networking system 140 determines 310 the current location as a physical location corresponding to the location information having a maximum value. Alternatively, the social networking system 140 determines 310 the current location of the user based on information received by the social networking system 140 from a client device 110 executing an application associated with the social networking system 140 and associated with the user, such as location information communicated to the social networking system from a position sensor (e.g., a Global Positioning System sensor) included in the client device 110.

The social networking system 140 compares 315 the current location associated with the user to the home location associated with the user and determines 320 whether the user is traveling based on the comparison. In one embodiment, the social networking system determines a distance between the current location associated with the user and the home location associated with the user and determines 320 whether the user is traveling by comparing the distance to a threshold value. If the distance equals or exceeds the threshold value, the social networking system 140 determines 320 the user is traveling. However, if the distance is less than the threshold value, the social networking system 140 determines 320 the user is not traveling. In other embodiments, the social networking system 140 uses any suitable method to determine 320 whether the user is traveling. In an alternative embodiment, the social networking system determines 320 whether the user is traveling based on a location type associated with the current location associated with the user. As described above in conjunction with FIG. 2, a location type associated with the current location describes one or more characteristics of the current location. Examples location types include a personal location (e.g., a tourist location or an entertainment location) and a business location type (e.g., convention center, professional conference, or office building). The social networking system 140 determines a location type associated the current location using information extracted from one or more content items associated with the user (e.g., a post shared by the user, a check-in to a location by the user, an acceptance of an invitation to an event by the user, calendar information associated with the user) and also associated with the current location. Using the extracted information about the current location, the social networking system 140 determines a location type associated with the current location and determines 320 whether the user is traveling based on the determined location type.

Based on the determination whether the user is traveling, the social networking system 140 stores 325 a travel status in the user profile associated with the user. In one embodiment, the travel status is stored 325 in response to determining 320 the user is traveling. Alternatively, a value for the travel status is stored 325 in response to determining 320 the user is traveling and an alternative value for the travel status is stored 325 in response to determining 320 the user is not traveling.

In some embodiments, the social networking system 140 also determines a type of travel after determining 320 the user is traveling. The social networking system 140 may determine a type of travel based on information associated with the user received by the social networking system 140. For example, the social networking system 140 retrieves content associated with the user including location information corresponding to the current location or retrieves content associated with the user and received within a threshold amount of time from determining 320 the user is traveling. Additional users connected to the user and also associated with the retrieved content are identified and the social networking system 140 determines whether the travel is business travel or personal travel based on types of connections between the user and the additional users. For example, if at least a threshold number of additional users have connections to the user indicating the user and the additional users are coworkers, the type of travel is determined to be business travel. Alternatively, if at least a threshold number of additional users have connections to the user indicating the user and the additional users are family or classmates, the type of travel is determined to be personal travel. As another example, information from user profiles associated with the additional users is retrieved and if at least a threshold number or percentage of the additional users specify an employer in their user profiles matching an employer specified by a user profile of the user, the type of travel is determined to be business travel.

Similarly, information from user profiles associated with the additional users may be retrieved, and if at least a threshold number or percentage of the additional users specify a hometown, a social organization, or a religious organization in their user profiles matching a hometown, a social organization, or a religious organization specified by a user profile of the user, the type of travel is determined to be personal travel. In another example, the social networking system 140 extracts words or phrases from content associated with the current location and analyzed to determine whether the type of travel is business travel or personal travel (e.g., various words or phrases may be associated with business travel or personal travel by the social networking system 140 and compared to words or phrases extracted from content associated with the current location). In a further example, if at least a threshold number of additional users have connections to the user indicating the user and the additional users have a business and a personal relationship, the social networking system determines which type of relationship is predominant based at least in part on a comparison between the number of the additional users having personal connections to the user and the number of the additional users having business connections to the user. For example, the type of relationship between the users and the additional connections is determined to be the type of connection associated with a greater number of connections between the user and additional users. Information identifying a type of travel may be stored in the user's user profile along with the travel status value.

Based at least in part on the travel status stored 325 in the user profile, the social networking system 140 selects 330 content for presentation to the user. Additionally, a type of travel associated with a travel status indicating the user is traveling may also be used to select 330 content for presentation to the user. For example, the social networking system 140 determines whether the travel status in the user profile matches travel statuses specified by targeting criteria included in various ad requests. Ad requests including targeting criteria specifying a travel status matching the travel status included in the user profile are identified as eligible for presentation to the user and included in a selection process identifying advertisement content for presentation to the user, as described above in conjunction with FIG. 2. A type of travel included in targeting criteria of an ad request may also be compared to a type of travel included in the user profile, with an ad request identified as eligible for presentation to the user if the travel status specified by targeting criteria of the ad request matches the travel status included in the user profile and the type of travel specified by targeting criteria of the ad request also matches the type of travel included in the user profile.

Additionally, the travel status included in the user profile may be used to select 330 other types of content items, including news stories, audio data, video data, image data, recommendations for interactions with the social networking system 140, other suitable content for presentation to the user. In one example, the travel status is used to select one or more content items to include in a newsfeed presented to the user associated with the travel status. Based at least in part on the travel status associated with the user, the social networking system 140 selects candidate content items and ranks the content items for inclusion in the newsfeed for display to the user. Using the travel status, the social networking system 140 selects one or more candidate content items to include in the newsfeed based at least in part on one or more relevance factors. For example, the social networking system 140 selects candidate content items having at threshold measure of relevance to a particular type of travel status. Example relevance factors include a relationship between a topic associated with a content item and a travel status as well as the current location associated with a user, information associated with the content item indicating a threshold level of proximity to the current location, or other suitable indication that a content item is relevant to the current location associated with the traveling user and to the travel status of the traveling user. For example, for a user whose travel status indicates that the user is traveling for business, the social networking system 140 selects content items having at least a threshold relevance to a travel status indicating business travel, such as an article that summarizes of highlights from a business conference identified as the user's current location, a post describing a review of a restaurant near a convention center hosting the business conference, or a schedule for transit operating near the convention center generated from an application installed in the social networking system 140 by the traveling user.

In another example, a measure of affinity of the user for a content item (e.g., a story describing an action performed by another social networking system user) associated with a location within a threshold distance of the user's current location is increased if the travel status in the user profile indicates the user is traveling. As another example, a measure of affinity of the user for content items including one or more terms or phrases associated with travel if the travel status in the user profile indicates the user is traveling. Modifying the measures of affinity of the user for various content items increases the likelihood of the content items being presented to the user. Similarly, measures of affinity of the user for various content items may be increased if the content item is associated with business travel and the type of travel in the user profile indicates the user is traveling for business, while measures of affinity of the user for content items associated with personal travel are increased if the type of travel in the user profile indicates the user is traveling for personal reasons.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining a user profile for a user of a social networking system that includes a home location associated with the user;
determining a current physical location associated with the user based on information associated with the user and received by the social networking system;
comparing the home location to the determined current physical location associated with the user;
determining whether the user is traveling based at least in part on the comparison;
storing a status associated with the user indicating the user is traveling in response to determining the user is traveling; and
selecting content for presentation to the user based at least in part on the status indicating the user is traveling.

2. The method of claim 1, wherein the home location is a physical location specified by the user.

3. The method of claim 1, wherein the home location specifies a residence.

4. The method of claim 1, wherein the home location is determined based on information identified from content provided to the social networking system by the user.

5. The method of claim 1, wherein determining the current physical location associated with the user comprises:
retrieving content provided to the social networking system by the user; and
determining the current physical location from location information associated with the content provided to the social networking system from the user.

6. The method of claim 5, wherein the content provided to the social networking system by the user is selected from a group consisting of: a check-in to a location associated with the user, a status update including location information, an invitation to an event including location information, calendar information including location information, and any combination thereof.

7. The method of claim 1, wherein the current physical location associated with the user is determined based at least in part on information provided to the social networking system from a position sensor included in a client device associated with the user.

8. The method of claim 1, wherein comparing the home location to the determined current physical location of the user comprises:
determining a distance between the home location and the determined current physical location of the user.

9. The method of claim 8, wherein determining whether the user is traveling based at least in part on the comparison comprises:
determining whether the distance equals or exceeds a threshold amount; and
determining the user is traveling if the distance equals or exceeds the threshold amount.

10. The method of claim 1, wherein determining whether the user is traveling based at least in part on the comparison comprises:
determining a type of travel based at least in part on content associated with the user by the social networking system in response to determining the user is traveling.

11. The method of claim 10, wherein selecting content for presentation to the user based at least in part on the status indicating the user is traveling comprises:
selecting the content based at least in part on the determined type of travel.

12. The method of claim 10, wherein the type of travel is selected from a group consisting of: a type indicating personal travel and a type indicating business travel.

13. The method of claim 1, wherein selecting content for presentation to the user based at least in part on the status indicating the user is traveling comprises:
identifying one or more advertisement requests including targeting criteria specifying association of an indication the user is traveling associated with the user; and
selecting an advertisement request from the identified one or more advertisement requests.

14. A method comprising:
maintaining a user profile for a user of a social networking system that includes a home location associated with the user;
determining a current physical location associated with the user based on information associated with the user and received by the social networking system;
comparing the home location with the determined current physical location of the user;
determining whether the user is traveling based at least in part on the comparison; and
selecting content for presentation to the user based at least in part on the determination of whether the user is traveling.

15. The method of claim 14, wherein the home location is a physical location specified by the user.

16. The method of claim 14, wherein determining the current physical location associated with the user comprises:
retrieving content provided to the social networking system by the user; and
determining the current physical location from location information associated with the content provided to the social networking system from the user.

17. The method of claim 14, wherein the current physical location associated with the user is determined based at least in part on information provided to the social networking system from a position sensor included in a client device associated with the user.

18. The method of claim 14, wherein determining whether the user is traveling based at least in part on the comparison comprises:
determining the user is traveling if a distance between the current location and the home location equals or exceeds the threshold amount.

19. The method of claim 14, wherein selecting content for presentation to the user based at least in part on the determination of whether the user is traveling comprises:
responsive to determining the user is traveling, identifying one or more advertisement requests including targeting criteria specifying association of an indication the user is traveling associated with the user; and
selecting an advertisement request from the identified one or more advertisement requests.

20. A computer program product comprising a computer readable storage medium having instructions encoded thereon that, when executed by a processor, cause the processor to:
maintain a user profile for a user of a social networking system that includes a home location associated with the user;
determine a current physical location associated with the user based on information associated with the user and received by the social networking system;
compare the home location with the determined current physical location of the user;
determine whether the user is traveling based at least in part on the comparison; and
select content for presentation to the user based at least in part on the determination of whether the user is traveling.
